(19) United States
(12) Patent Application Publication
(10) Pub. No.: US 2023/0253010 A1
(43) Pub. Date: Aug. 10, 2023

(54) VOICE ACTIVITY DETECTION (VAD) BASED ON MULTIPLE INDICIA

(71) Applicant: Analog Devices International Unlimited Company, Limerick (IE)

(72) Inventors: Sudheer Babu, Therlam mandal (IN); Deepak Raghotham, Bangalore (IN); Norbert Raecke, Berlin (DE); Dietmar Ruwisch, Berlin (DE); Sivaramakrishnan Subramanaiam, Bangalore (IN)

(21) Appl. No.: 18/158,358

(22) Filed: Jan. 23, 2023

Related U.S. Application Data
(60) Provisional application No. 63/306,790, filed on Feb. 4, 2022.
(60) Provisional application No. 63/373,804, filed on Aug. 29, 2022.

(51) Int. Cl. G10L 25/78; G10L 25/24; G10L 25/51

(52) U.S. Cl. CPC G10L 25/78; G10L 25/24; G10L 25/51; G10L 2025/783

(57) ABSTRACT

In an example, a machine-implemented method for detecting voice activity may include receiving a digital representation of an audio signal. The method may also include applying a first stage which may include determining a first frequency-domain indicator from the digital representation of the audio signal to identify a candidate speech duration. The method may also include applying a second stage which may include determining at least one of a mel-frequency cepstral (MFC) indicator or a pitch indicator from the digital representation of the audio signal to assess whether the identified candidate speech duration contains speech.

### CLAIM OF PRIORITY

This patent application claims the benefit of priority of Babu et al., U.S. Provisional Pat. App. Serial No. 63/306,790, entitled “VOICE ACTIVITY DETECTION (VAD) BASED ON MULTIPLE INDICIA,” filed on Feb. 4, 2022 (Attorney Docket No. 3867.896PRV), and Babu et al., U.S. Provisional Pat. App. Serial No. 63/373,804, entitled “VOICE ACTIVITY DETECTION (VAD) BASED ON MULTIPLE INDICIA,” filed on Aug. 29, 2022 (Attorney Docket No. 3867.896PV2), which are hereby incorporated by reference herein in their entirety.

### TECHNOLOGICAL FIELD

This document pertains generally, but not by way of limitation, to automated detection of human vocal activity, and more particularly to providing an indication of voice activity using multiple indicia.

### BACKGROUND

Emerging human-machine interfaces increasingly support use of voice commands or more generally, monitoring of voice activity such as for contextual identification of distress, detection of explicit requests, or for security applications, as illustrative examples. Voice activity detection (VAD) generally refers to detection of human vocalization without requiring a particular language context or “wake” word or complementing a system that uses a wake word for context identification. Detection of voice activity may be performed in the presence of other acoustic sources including background noise (e.g., vehicular noise), or unfavorable acoustic artifacts such as multi-path effects (e.g., echoes).

### SUMMARY

VAD may be used with an automated system, or a system that is capable of performing automated activities (e.g., a mobile phone or other device, such as communicatively coupled to another system using a network). For example, the present subject matter can be used to flag audio data as containing a probable beginning and or a probable end of a duration of human speech, or to otherwise indicate the presence or absence of durations where a specified likelihood exists that human speech is present. A system can use data indicative of such classification to, for example, (1) know when commands are being given, or (2) facilitate a lower-processor-load “rest” state when commands are not being given, which may conserve one or more of power, bandwidth, memory, or another resource. In addition to detection of a specified “wake” word (or words), the present inventors have recognized that it may be desirable to detect a presence or absence of speech in a language-agnostic manner, such as may allow a VAD system to work for various users and regions without requiring regionalization or language-specific training.

In an automotive environment, a mobile phone or other mobile communication device may be paired (e.g., via a wireless networking protocol or other wireless interface protocol) with vehicular electronics. The vehicular electronics or another device can be configured to perform VAD according to the present subject matter, such as permitting or suppressing transmission of streaming audio to the mobile phone or other device based on one or more indicia provided by VAD techniques as described herein. In this manner, a mobile device need not monitor an audio stream continuously for a wake word or other indicia of voice activity, saving power or network bandwidth. Audio components, such as microphones, amplifiers, and filters, included as a portion of a vehicular electronic system can be configured to operate in an environment having different background noise or acoustic artifacts than other environments.

The techniques described herein can also support variable latency in relation to supplying an audio stream to another device. For example, after voice activity has been flagged, a latency related to audio transmission can be reduced so that an automated system can further process the flagged voice activity more promptly. It may be desirable to reduce a latency time between when speech is commenced and when the digital representation of the recorded speech is passed to an automated system. A maximum latency may be specified by an automated system manufacturer (e.g., a mobile phone manufacturer). Reducing latency may be helped by one or more of more precise processing, quicker processing, more selective metrics, or better VAD methods.

The present inventors have recognized that detection of voice activity can present various challenges, particularly in a noisy environment. In one approach, time-domain techniques can be used to digitally perform voice activity detection (e.g., flagging, identifying, or classifying temporal durations such as acoustic “frames” as speech or non-speech). For example, an envelope-based approach can be used. Such an approach can present various drawbacks, such as misclassifying non-speech sounds having sufficient energy to trigger the classifier as speech. Standards for VAD have been established, such as described in ITU-T recommendation G.729 (06/12) and ETSI AMR-2 (ETSI TS 126 094 V4.00 (2001-03) “Universal Mobile Telecommunication Systems (UMTS); Mandatory Speech Codec speech processing functions, AMR speech codec; Voice Activity Detector (VAD) (3GPP TS 26.094 version 4.0.0 Release 4),” but such standards may still perform poorly in noisy environments. In yet another approach, a machine learning technique can be used, such as implemented in the WebRTC open-source project (https://webrtc.org/), however the WebRTC implementation version 1.0 may also fail to meet certain voice detection specificity thresholds and may not support tuning of internal detection parameters (e.g., providing only a “black box” detection module). In yet another approach, a spectral entropy (SE) determination can be used for classification, however such an approach can be susceptible to false triggering when subjected to impulsive noise having energy ranging across a broad spectrum.

In view of the challenges mentioned above, the present inventors have recognized, among other things, that VAD can be performed using multiple indicia, such as using data derived from one or more of the frequency domain, the mel-frequency cepstral domain, or the cepstral domain. A multi-stage approach may be used with respective indicia either: (1) flagging a specified duration as a candidate speech interval potentially containing speech, or (2) flagging one or more portions of a previously identified candidate speech interval as likely containing speech. Portions of a candidate speech interval flagged as likely containing speech can be output. Such an output can be used by other elements of a system, such as to trigger further processing to detect a wake word, or an oral request or command, or to commence other activities such as logging durations where activity is detected or triggering recording an audio stream, as illustrative examples.

In an example, a machine-implemented method for detecting voice activity may include receiving a digital representation of an audio signal. The method may also include applying a first stage which may include determining a first frequency-domain indicator from the digital representation of the audio signal to identify a candidate speech duration. The method may also include applying a second stage which may include determining at least one of a mel-frequency cepstral (MFC) indicator or a pitch indicator from the digital representation of the audio signal to assess whether the identified candidate speech duration contains speech.

In an example, a machine-implemented method for detecting voice activity may include receiving a digital representation of an audio signal. The method may also include establishing respective frames defining specified durations within the digital representation of the audio signal. The method may also include applying a first stage comprising determining a first frequency-domain indicator from at least one of the respective frames of the digital representation of the audio signal to identify a candidate speech duration. The method may also include applying a second stage comprising determining a mel-frequency cepstral (MFC) indicator from at least one of the respective frames of the digital representation of the audio signal to assess whether the identified candidate speech duration contains speech.

In an example, a voice activity detection (VAD) system may include a receiver circuit, configured to receive a digital representation of an audio signal. The system may also include a processor circuit coupled with a memory circuit, the memory circuit containing instructions that, when executed by the processor circuit, may cause the processor circuit to: apply a first stage which may include determining a first frequency-domain indicator from the digital representation of the audio signal to identify a candidate speech duration; and apply a second stage which may include determining at least one of a mel-frequency cepstral (MFC) indicator or a pitch indicator from the digital representation of the audio signal to assess whether the identified candidate speech duration contains speech.

This summary is intended to provide an overview of the subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which may not be drawn to scale, like numerals may describe substantially similar components throughout one or more of the views. Like numerals having different letter suffixes may represent different instances of substantially similar components. The drawings illustrate generally, by way of example but not by way of limitation.

FIG. 1 is a block drawing of an example of a portion of a voice activity detection system.

FIG. 2A and FIG. 2B are block drawings of an example of a portion of a voice activity detection technique, such as corresponding to the system shown in FIG. 1.

FIG. 3A, FIG. 3B, and FIG. 3C are plots illustrating generally an example comprising establishing an indicator for use in performing voice activity detection.

FIG. 4A, FIG. 4B, and FIG. 4C are plots illustrating generally an example comprising establishing yet another indicator for use in performing voice activity detection.

FIG. 5A and FIG. 5B are plots illustrating generally an example comprising establishing yet another indicator for use in performing voice activity detection.

FIG. 6A shows a technique for establishing a threshold and comparison value, and FIG. 6B shows an output of a classifier applying an indicator using the threshold and comparison value from FIG. 6A.

FIG. 7A and FIG. 7B show illustrative examples of outputs corresponding to indicators from a portion of a voice activity detection system.

FIG. 8 shows an illustrative example of outputs corresponding to indicators from a portion of a voice activity detection system.

FIG. 9A, FIG. 9B, and FIG. 9C show illustrative examples of outputs corresponding to indicators from a portion of a voice activity detection system.

FIG. 10 is a flow chart showing an example of a method for operating portions of a voice activity detection system.

FIG. 11 is a block diagram illustrating an example of a machine upon which one or more methods may be implemented.

### DETAILED DESCRIPTION

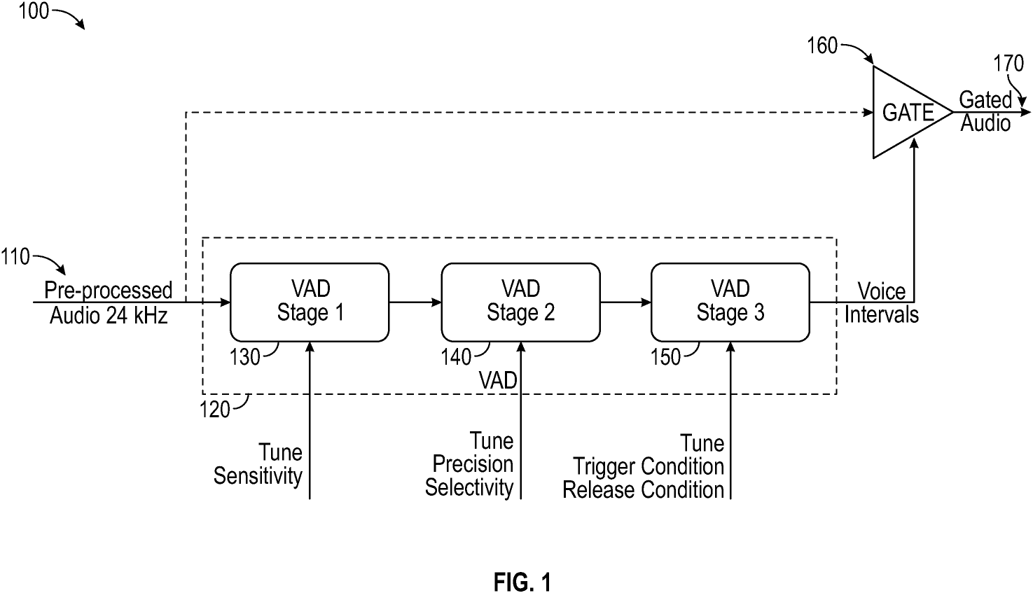

FIG. 1 is a block drawing of an example of a portion of a voice activity detection (VAD) system 100. FIG. 1 shows an incoming digital audio signal node 110, a voice activity detection block 120, a gate block 160, and an outgoing gated digital audio signal node 170. Data provided at the incoming digital audio signal node 110 may be pre-processed before being passed to the voice activity detection block 120. The voice activity detection block 120 may include a first stage 130, a second stage 140, and a third stage 150. The audio signal from the incoming digital audio signal node 110 may pass through one or more of the voice activity detection block 120 components one or more of sequentially, serially, partially concurrently, or in parallel. The gate block 160 may receive as inputs data on the incoming digital audio signal node 110 and the output of the voice activity detection block 120. The gate block 160 may produce as an output to the outgoing gated digital audio signal node 170 one or more portions of the audio signal on the incoming digital audio signal node 110 that the voice activity detection block 120 flagged as likely containing speech.

The first stage 130 may be the first portion of the voice activity detection block 120 to operate on a digital representation of an audio signal from the incoming digital audio signal node 110 and may identify or flag a candidate speech interval or candidate speech duration that may contain speech. The first stage 130 may be configured to have a specified latency, or to have a latency less than or equal to a specified latency. The first stage 130 may be configured to flag as a candidate speech interval any interval that has a specified set of characteristics, even though the specified characteristics may not be dispositive of speech (e.g., sensitivity may be emphasized over specificity in terms of identification of a likelihood that a candidate interval contains speech). In an example, the first stage 130 may be configured to have a specified latency, such as may result in a specified level of accuracy.

The second stage 140 may operate on all of the digital audio signal from the incoming digital audio signal node 110, or it may only operate on the portions flagged as candidate speech intervals by the first stage 130 (e.g., in a cascaded manner). The second stage 140 may apply one or more additional processing steps to help determine whether an interval likely contains speech.

The third stage 150 may operate on all incoming respective frames or other portions of the digital audio signal from the incoming digital audio signal node 110, or it may only operate on the portions flagged as likely containing speech by the second stage 140 (e.g., in a cascaded manner). The third stage 150 may apply one or more additional processing steps to help make a determination as to whether an interval likely contains speech. Other topologies can be used, with the example of three stages being illustrative.

Once an interval has been flagged as likely containing speech by the voice activity detection system 100, it may be passed as a digital audio signal to another system on the outgoing gated digital audio signal node 170. While an interval or portion of an interval is being analyzed to determine whether it likely contains speech, the digital audio signal from the incoming digital audio signal node 110 may be stored in memory (e.g., buffered) within the voice activity detection system 100 so that the voice activity detection system 100 can pass the digital audio signal to the other system without losing data after a determination is made, for example, when an interval has been flagged as likely containing speech. If there is a speech interval that is long compared to the detection latency of the voice activity detection system 100, the passing of one or more portions of the audio signal to the other system may occur at least partially concurrently with one or more portions of the audio signal being received on the incoming digital audio signal node 110. In an example, once an interval is flagged as likely containing speech, the stored portion of the interval may be transmitted to the other system at a specified burst speed and the remaining portion of the interval can be transmitted in real-time or near real-time, such as may include without being separately buffered by the voice activity detection system 100. When a likely end to a speech interval is determined by the voice activity detection block 120, a burst or streaming transfer mode can be ended, or such burst or streaming transfer can be terminated by a device receiving the audio data from the voice activity detection system 100. Operation of voice activity detection may result in an initial delay, such as may be during the initial determination by the voice activity detection block 120 as to whether an interval likely contains speech. Latency can be reduced by transitioning to a burst or streaming mode, such as once an interval is flagged as likely containing speech. Generally, detection of an initiation of speech may be emphasized. The system 100 need not stop capturing as soon as speech ends. For example, a period of time where no speech is detected could be transmitted in real time before the likely lack of speech is declared or otherwise flagged.

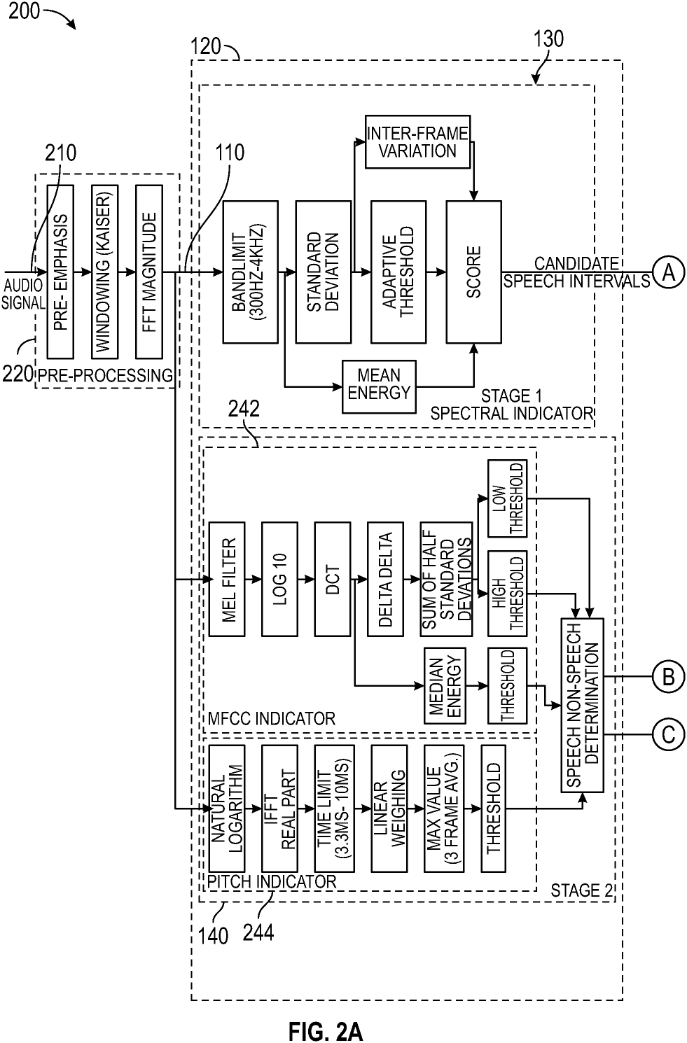

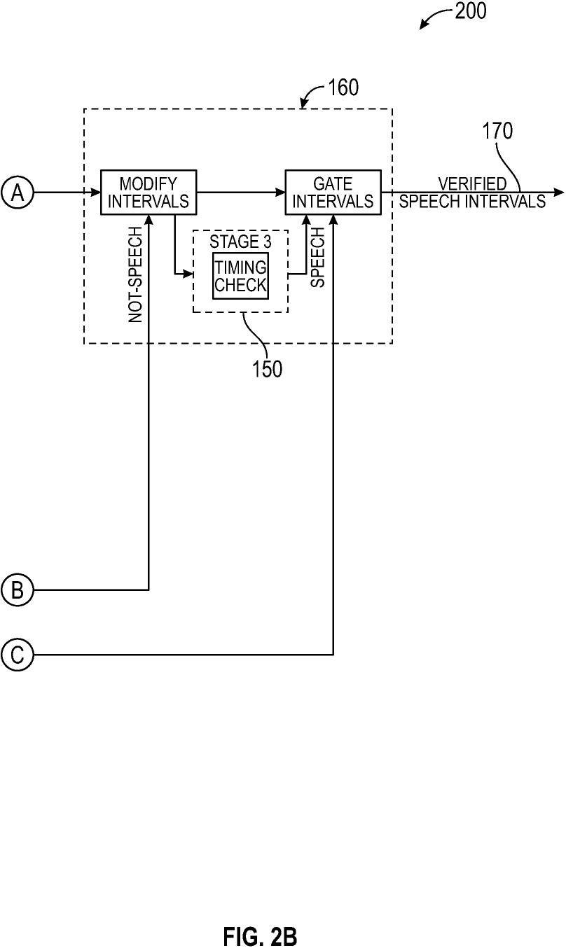

FIG. 2A and FIG. 2B are block drawings of an example of a portion of a voice activity detection technique 200, such as corresponding to the system 100 shown in FIG. 1. FIG. 2B is a continuation of FIG. 2A joined at connection points A, B, C, and D. The voice activity detection technique of FIG. 2A and FIG. 2B may be configured for performing voice activity detection using multiple indicia. The indicators shown in FIG. 2A may be sensitive, yet selective to speech, without requiring a particular language context. The approach shown in FIG. 2A and FIG. 2B may reduce or suppress false triggering on noises found in, for example, an automotive environment, such as engine/road noise, thuds produced when a vehicle goes over a speed breaker or traverses an uneven surface, noise due to wind when windows are rolled down, noise due to fans (e.g., climate control fans), or noise due to other vehicles, as illustrative examples.

The technique 200 shown in FIG. 2A and FIG. 2B can be implemented in whole or in part using a digital signal processor (DSP) or other platform, such as to provide real-time or near-real-time processing (e.g., on a frame-by-frame basis when provided with an audio stream). Generally, the approach shown in FIG. 2A and FIG. 2B combines information from both a spectrum (e.g., a frequency domain representation) and a cepstrum (e.g., an inverse transform of a logarithmically scaled representation of the frequency domain representation). The approach shown in FIG. 2A and FIG. 2B can be applied to a single audio frame or multiple audio frames, such as may help to achieve high sensitivity and specificity to speech versus other audio sources. Generally, the approach shown in FIG. 2A and FIG. 2B can provide the determination of three or more different indicators. The three or more different indicators can be binary indicators with either a speech or no speech indication, or score values, such as may include an integer or floating-point value. The combination of the three or more different indicators may be completed with one or more of digital logic, score weighting, or machine learning. In an example, the output of one or more indicators may be dispositive of speech. In an example, the output of one or more indicators may be combined to determine if speech is present. In an example, the three or more different indicators can then be provided to a decision process to aggregate individual scores from the respective indicators to provide an overall voice activity detection determination.

In the example of FIG. 2A and FIG. 2B, the voice activity detection technique 200 may include an incoming digital audio node 210, a pre-processing stage 220, a first stage 130, a gate block 160 and an outgoing gated digital audio signal node 170. The voice activity detection block 120 may include a first stage 130, a second stage 140, and a third stage 150.

The pre-processing stage 220 may include one or more digital signal processing steps such as may include one or more of pre-emphasis, windowing, or a fast Fourier transform (FFT). The pre-emphasis step may one or more of attempt to make the signal easier to process, attempt to make the energy distribution more uniform across the spectrum, or attempt to correct for a non-linearity in the signal chain, such as may be due to a non-linearity of a microphone. In an example, the pre-emphasis may emphasize a specified range of frequencies, such as may include frequencies in the upper range of the audio signal. This may be due to some speech signals having a higher energy in the lower portion of the spectrum. The windowing step may divide the audio signal received on the incoming digital audio node 210 into respective frames. The digital audio signal received on the incoming digital audio node 210 may be one or more of a continuous (e.g., streamed) signal or discrete audio frames. In an example, the signal may be a stream of frames with each frame corresponding to a specified duration, such as may correspond to a digital sampling frequency. The windowing step may establish respective frames by dividing the incoming audio signal into frames by simply grouping digital values, or the windowing step may attempt to smooth or taper the edges of the window using a method such as Kaiser windowing. Windowing may help the FFT step by providing a discrete set of values representing a specified timespan for the FFT to operate on. Windowing may help reduce spectral leakage, which may be an artefact of breaking a signal into smaller portions and determining the FFT of the smaller portions as opposed to determining the FFT of the entire signal. Without windowing, or with large frames, the FFT may one or more of introduce undesirable latency or produce a less meaningful output. The windowing step may produce frames having a defined duration in time. The windowing step may produce frames with a defined number of digital data points. The windowing step may establish respective frames by assigning or receiving the respective frames based upon the streamed representation of an audio signal received at the incoming digital audio node 210.

The FFT step may take the fast Fourier transform of the input, such as may include the output of the pre-emphasis and windowing steps and generate an output indicative of the spectrum. The output may include a magnitude of the analyzed frame at various frequencies. The first stage 130 may be configured to analyze frames to identify candidate speech windows that may contain speech. The first stage 130 may receive as an input the output of the pre-processing stage 220 and may include one or more of a band limiting filter, a standard deviation block, an adaptive threshold block, and a scoring block.

The band limiting filter may remove or reduce the magnitude of bands in the frequency spectrum that are outside of the frequencies commonly produced in speech, such as may include one or more of below 300 Hz or above 4 kHz. The standard deviation block may calculate the standard deviation of the spectrum, such as may result in a measure of the dispersion or spread in the energy across the spectrum. A standard deviation value extracted from the spectrum may be compared to a threshold, such as may include one or more of a specified fixed threshold or a variable (e.g., adaptive) threshold. The threshold comparison block may generate a binary or ordinal score to send to the score block.

The first stage 130 may also include an inter-frame variation block to measure the variation of a determined frequency spectrum standard deviation between frames and a mean energy block to measure the mean energy of a band-limited spectrum. The outputs from the inter-frame variation block and the mean energy block may also send a binary or ordinal score to the score block. The first stage 130 may operate on a single frame at a time, or more than one frame at a time. The first stage 130 may contain memory which may allow the comparison and averaging of the results of multiple frames. The various binary and ordinal scores and metrics may be one or more of weighted, averaged, combined using digital logic, or otherwise processed to result in flagging candidate speech intervals.

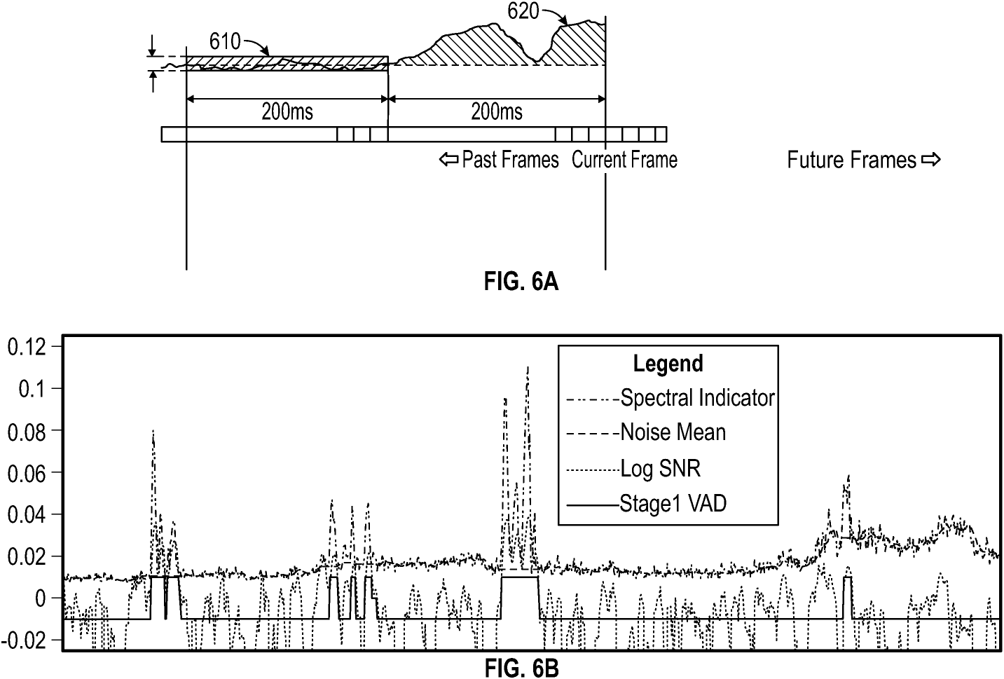

Use of an adaptive threshold (discussed in greater detail with respect to FIG. 6A and FIG. 6B, below) may help the voice activity detection system 100 to be more accurate over a range of varying conditions, such as may include varying speeds, road surfaces, or other conditions that affect the ambient noise level. For example, the threshold may increase as the car accelerates and the cabin becomes noisier, which may result in one or more of a higher mean energy or higher standard deviation of the frequency spectrum even when speech is not present.

In audio data containing speech, the output of the FFT may show one or more of a greater average magnitude or a greater variation in frequencies, or both, compared to an FFT output where speech is absent. In audio data of common sources of noise, the output of the FFT may show one or more of a lower average magnitude or less variation in frequencies. This may allow the first stage 130 to identify candidate speech intervals by calculating and using one or more of the standard deviation and mean energy of the audio input signal. Additionally, a frequency distribution of energy associated with speech may vary more over time than common ambient noise sources, which may allow the use of the variation between frames (e.g., across time) to help determine candidate speech intervals.

The second stage 140 may receive as an input the output of the pre-processing stage 220 and may include one or more of a mel-frequency cepstral coefficient (MFCC) indicator 242, a pitch indicator 244, and a speech determination block. The MFCC indicator may include one or more of a mel filter, a Log_10 block, a discrete cosine transform (DCT) block, a delta-delta block, a standard deviation block, a high threshold, and a low threshold.

The MFCC indicator may determine MFC coefficients for durations of digital data extracted from a digital representation of the audio input. For example, a mel-frequency filter may map the spectral output from the pre-processing stage 220 onto the mel scale to generate a mel-frequency spectrum. A mel-frequency spectrum may be an empirically determined spectrum intended to provide a perceptually uniform (or near perceptually uniform) assignment of energy from an incoming signal into mel-frequency bins. For example, equal increments of frequency may not be perceived by the human ear as equal increments. Use of a mel-frequency representation creates bins that are equally spaced, but on a mel scale rather than a linear frequency scale. The mel-frequency spectrum output from the mel-frequency filter may be passed through the Log_10 block to calculate the base 10 logarithm of mel-frequency values in the mel-frequency spectrum. The output from the Log_10 block may be passed through the DCT block to produce an MFCC spectrum. For example, the mel-frequency spectrum, after passing through the Log_10 block, can be transformed by the DCT as if it were a time series, where the base-10 logarithm of each mel-frequency bin value is provided as an input series to the DCT block to provide the MFCC spectrum as the resulting transformed output of the DCT block.

The MFCC spectrum may be broken into a number of bins, such as may include 10 bins, 15 bins, 20 bins, 30 bins, or 40 bins, as illustrative examples The delta-delta block may calculate the difference between adjacent bins for a given frame to produce an intermediate set of delta values, and may then calculate the differences between intermediate sets of delta values between frames (e.g., across time) to determine the final delta-delta values. The standard deviation block may divide the delta-delta output into two halves, each containing half of the MFCC bins, and calculate the standard deviation of each half and then sum the standard deviations of the halves. The sum of standard deviations may then be compared to a high and low threshold. If the sum of standard deviations is consistently above the high threshold, a candidate speech interval may be flagged as likely containing speech. If the sum of standard deviations is consistently below one or more of the high threshold or the low threshold, a candidate speech interval may not be flagged as likely containing speech. The MFCC indicator 242 may help detect speech because human speech has one or more of a broader mel-frequency spectrum or more rapid variation across bins than many common ambient noises, and such a mel-frequency spectrum varies over time.

The MFCC indicator 242 may also include a median energy block and a threshold block. The median energy block may calculate the median or mean energy of the MFCC spectrum. If the median is below a threshold, the MFCC indicator 242 may not flag the candidate speech interval as likely containing speech even if the sum of standard deviations is above the high threshold. This may help the voice activity detection system 100 properly identify the likely lack of speech when the sum of standard deviations is high due to noise or other phenomena, but the overall energy of the signal is low, which may indicate that there is no speech present.

The pitch indicator 244 may include one or more of a natural logarithm block, an inverse fast Fourier transform (IFFT) block, a time limit block, a linear weighing block, a max value block, and a threshold block. The pitch indicator 244 may be connected to the output of the pre-processing stage 220 and may calculate the cepstrum of the input digital audio signal on the incoming digital audio node 210. The natural logarithm block may calculate the natural logarithm of the spectrum output by the pre-processing stage 220. The IFFT block may calculate the real IFFT of the output of the natural logarithm block to generate a real cepstrum. The time limit block may remove certain portions of the cepstrum, such as may include portions that are not good indicators of speech. In an example, the time limit block may produce the upper region of the cepstrum, such as may include from 3.3-10 milliseconds. The linear weighing block may one or more of weight and average various regions of the cepstrum or weight and average multiple frames. The max value block may calculate the maximum weighted value for the last three frames. The threshold block may compare the output of the max value block to a threshold, such as may include a fixed threshold. If the average value or other measure of central tendency is above the threshold, the candidate speech interval may be determined to be speech. If the average value is below the threshold, the candidate speech interval may be determined not to be speech.

Speech may include certain pitch characteristics that can be detected in the upper region of the cepstrum, which may make the pitch indicator 244 a helpful indicator of speech. However, in one or more of some sounds, some portions of words, some words, or some phrases, pitch may not be present. This may make it helpful to have other indicators of speech, such as may include the first stage 130, the MFCC indicator 242, and the third stage 150.

The speech determination block may combine one or more outputs from the MFCC indicator 242 and the pitch indicator 244 to make a determination of the second stage 140 as to whether a candidate speech interval likely contains speech. The speech determination block may also modify a candidate speech interval to add or remove frames. The speech determination block may use one or more of binary logic, or weighting of ordinal values.

The third stage 150 may include a timing check block. The timing check block may determine a temporal length of intervals that are flagged by the first stage 130 and second stage 140 as likely containing speech. The timing check block may determine that an interval that was determined to likely contain speech by the second stage 140 is not likely to contain speech if the interval is less than a specified duration. This may be helpful in reducing the number of non-speech events that are otherwise erroneously flagged as likely containing speech. Such non-speech events may include impulses or other ambient noises that have a shorter duration than is typical of actual speech.

The gate block 160 may include a block to modify intervals otherwise flagged as candidate speech intervals by the first stage 130, and a block to gate intervals otherwise flagged as candidate speech intervals by the first stage 130. The second stage 140 may instruct the modify block to adjust a candidate speech interval, such as modifying the boundaries of the candidate speech interval, by application of an indication from the second stage. The second stage 140 may instruct the gate block to permit or suppress a candidate speech interval, such as indicating to the gate block to permit or suppress a modified or unmodified candidate speech interval. The third stage 150 may instruct the gate block to permit or suppress a candidate speech interval. In an example, a suppress signal from the third stage 150 may override a permit signal from the second stage 140. The gate block 160 may include logic, memory, processors, or other hardware to consider one or more of the inputs from the voice activity detection block 120 in determining what audio data to permit or suppress on the outgoing gated digital audio signal node 170.

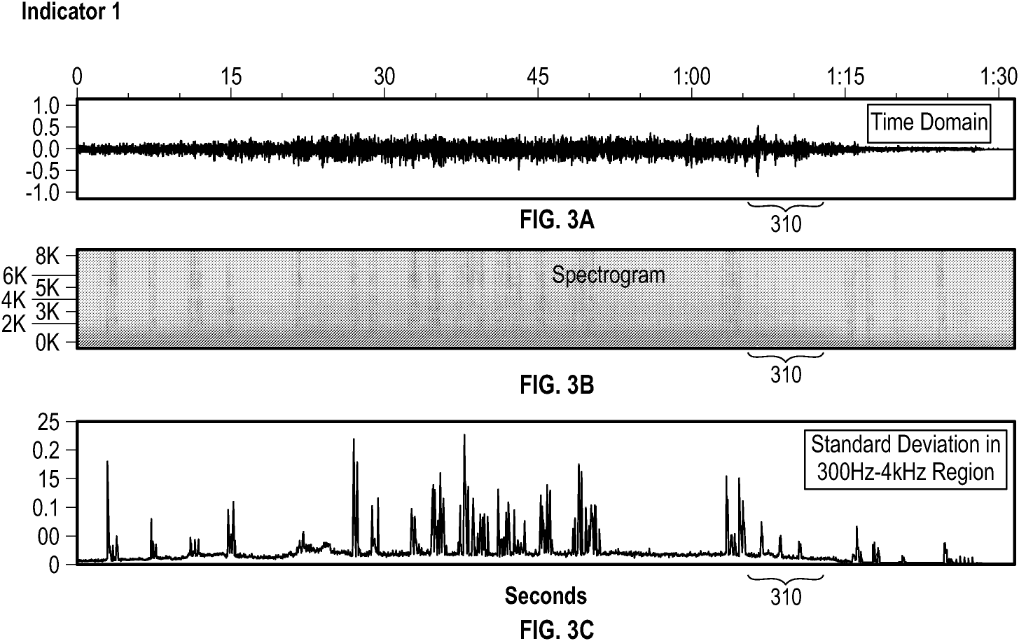

FIG. 3A, FIG. 3B, and FIG. 3C are plots illustrating generally an example comprising establishing an indicator for use in performing voice activity detection. In FIG. 3A, an experimentally obtained audio stream is shown, obtained from an automobile during a drive, with a person speaking. In FIG. 3B, a series of frequency domain representations are formed to provide the spectrogram with a horizontal axis representing time and a vertical axis representing frequency. In FIG. 3C, a dispersion determination is made (e.g., a standard deviation of spectrum in the voice frequencies (300 Hz-4 kHz)) for at least one of a frame or series of audio frames. Because speech may have energy in a wider frequency range compared to engine noise, a standard deviation of spectrum in regions containing speech may be one or more of significantly or noticeably different. However, impulsive sounds, such as thuds produced when the vehicle passes over uneven road surface, can also have a large spectral standard deviation. Additionally, speech is non-stationary from a statistical perspective, so the standard deviation is generally non-constant over a duration spanning an entire phoneme. For example, the highlighted region inside the duration 310 shows non-speech noise that registers a spike in the standard deviation plot at FIG. 3C. Accordingly, alone, the spikes in FIG. 3C can be used to indicate speech, but such an indicator may not be adequately selective when used alone.

FIG. 3A may represent the input audio signal on the incoming digital audio node 210. FIG. 3B may represent the output of the pre-processing stage 220 on the incoming digital audio signal node 110. FIG. 3C may represent the output of the standard deviation block in the first stage 130. The spikes in FIG. 3C may represent speech events. However, as discussed above, the spikes in the duration bounded by duration 310 are not speech events but instead the result of the car hitting a speed breaker. The first stage 130 may use the information in FIG. 3C to flag candidate speech intervals that may contain speech, and then rely on the second stage 140 and the third stage 150 to one or more of remove portions of intervals that do not likely contain speech or to remove complete intervals that do not likely contain speech. For example, the first stage 130 may have a desirable false negative rate, meaning that it rarely misses speech events, but may have an undesirable false positive rate, meaning that it misidentifies a number of events as speech that in fact do not contain speech. FIG. 3A, FIG. 3B, and FIG. 3C also show an increase in ambient noise due to the automobile accelerating, which can be seen as an increase in the average noise amplitude shown in FIG. 3A, as well as an increase in the standard deviation shown in FIG. 3C.

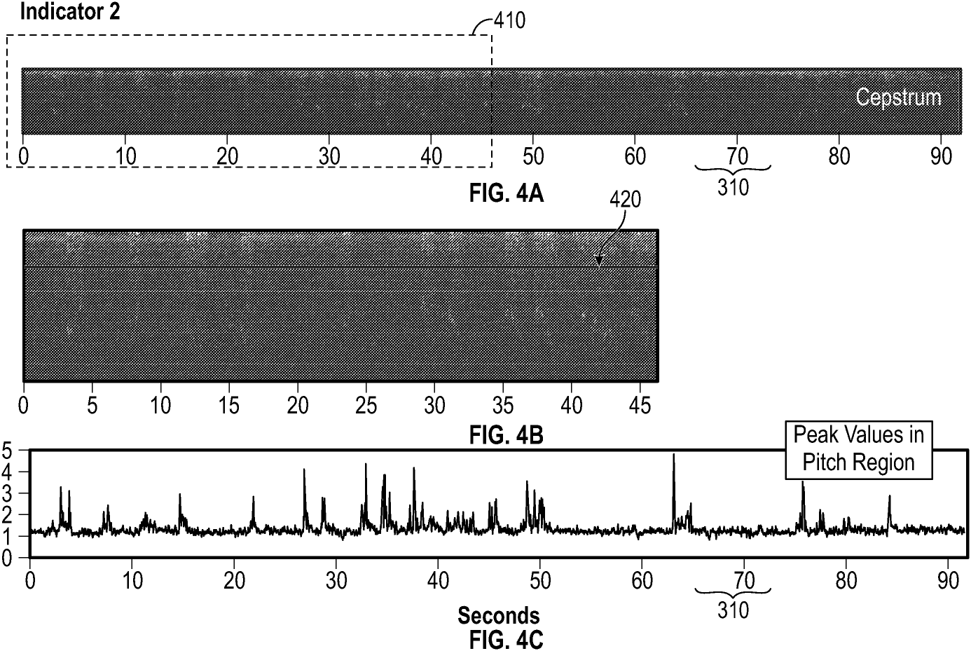

FIG. 4A, FIG. 4B, and FIG. 4C are plots illustrating generally an example comprising establishing yet another indicator for use in performing voice activity detection. FIG. 4A corresponds to the same data used in FIG. 3A. In FIG. 4A, a series of cepstral determinations are made, by determining a logarithm of magnitudes in the frequency domain representation, and performing an inverse transform, as shown illustratively in FIG. 2A, above. In FIG. 4A, and the detail shown in FIG. 4B, the horizontal axis represents time, and the vertical axis represents cepstral bin index (e.g., bin number corresponding to time index in the cepstral representation) with lower bin numbers shown at the upper portion of the plots in FIG. 4A and FIG. 4B, and higher bin numbers shown at the lower portion of the plots in FIG. 4A and FIG. 4B. Generally, peak values can be determined for a series of cepstral determinations for respective audio frames, as shown in FIG. 4C, where the upper region of the cepstrum captures the pitch information in speech (e.g., from about 3.3 milliseconds to about 10 milliseconds, or bins 80-240 corresponding to a sample rate of 24 kilohertz). However, not all sounds associated with speech carry pitch information. Pitch is generally an unambiguous indicator of speech, however it is present only in certain regions of speech. Also, pitch can get masked in the presence of driving noise. Relying on a pitch indicator alone can again lead to lower sensitivity.

FIG. 4A may represent the output of the IFFT block in the pitch indicator 244. FIG. 4B is a zoomed in view of the region of the cepstrum of FIG. 4A shown in the box 410. The line 420 in FIG. 4B denotes the time limit put on the cepstrum in the pitch indicator 244. The values above the line represent lower values that may be discarded and the values below the orange line represent upper values that may be further analyzed. FIG. 4C may be the output of the max value block in the pitch indicator 244. FIG. 4C shows that the audio signal produced from going over the speed breaker as shown in the duration 310 did not produce a response indicative of speech on the pitch indicator 244. This may allow the pitch indicator 244 to determine that the speed breaker was likely not speech and may help prevent the gate block 160 from permitting non-speech data corresponding to the speed breaker on the outgoing gated digital audio signal node 170. In an example, the voice activity detection system 100 may determine that a candidate speech interval likely contains speech if there is a single peak in the cepstral indicator shown in FIG. 4C above the specified threshold.

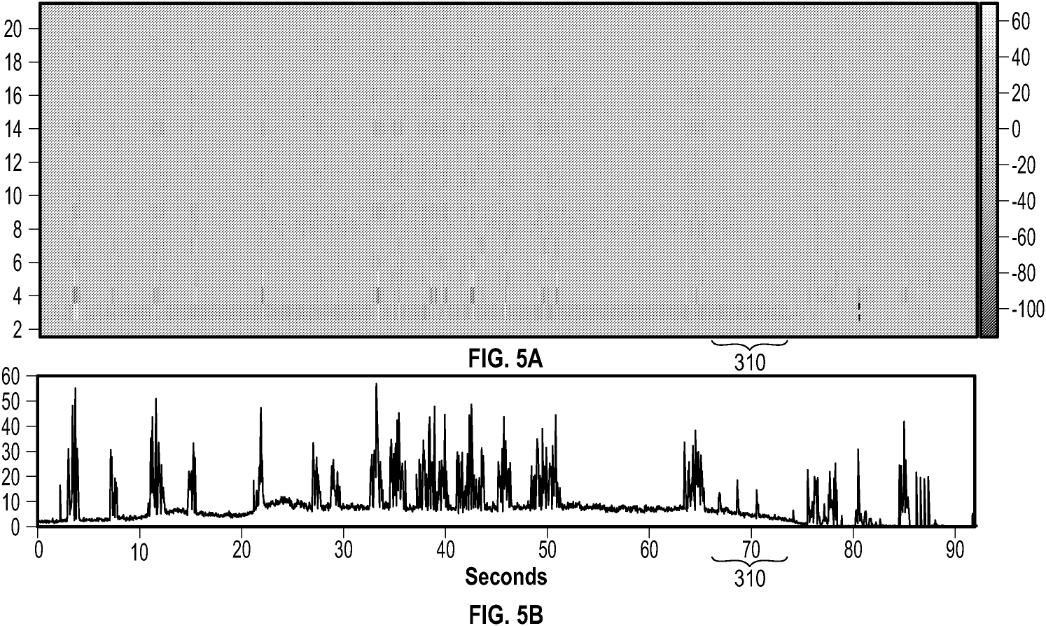

FIG. 5A and FIG. 5B are plots illustrating generally an example comprising establishing yet another indicator for use in performing voice activity detection. FIG. 5A correspond to the same data used in FIG. 3A and FIG. 4A. In FIG. 5A, the delta-delta values of the mel-frequency cepstral coefficients are determined by determining an intermediate difference between respective bins within a frame and then determining the difference in intermediate differences between frames, as shown illustratively in FIG. 2A, above. In FIG. 5A and FIG. 5B, the horizontal axis represents time. In FIG. 5A, the vertical axis represents the MFCC delta-delta bin index with lower bin numbers shown at the lower portion of the plot in FIG. 5A and upper bin numbers shown at the upper portion of the plot in FIG. 5A. In FIG. 5A, the mel cepstrum was divided into 20 bins. FIG. 5A may represent the output of the delta-delta block in the MFCC indicator 242. FIG. 5B shows the sum of the standard deviation of the upper 10 bins and the standard deviation of the lower 10 bins. Generally, a large value in FIG. 5B corresponds to a speech event. However, the speed breaker phenomena shown in duration 310 may also register in FIG. 5B. Given the short length of the speed breaker phenomena, the timing check in the third stage 150 could help to determine that these are likely not speech. In an example, the third stage 150 may flag an interval as likely not speech if it is less than 100 milliseconds, 200 milliseconds, 300 milliseconds, 400 milliseconds, or 500 milliseconds, as illustrative examples.

In FIG. 5A, speech may show up as frames that alternate between positive and negative within a frame, shown as a dark-to-light alternation. This indication may make the MFCC helpful in detecting speech. In FIG. 5A and FIG. 5B, the noise floor is also raised as the car accelerates, but the peaks caused by speech still stand out above the noise. At some operating conditions (e.g., cruising speed) the noise floor may drown out the speech indication. This may be helped by making the high and low thresholds in the MFCC indicator 242 adaptive or otherwise variable. In an example, one or more of the high threshold or low threshold are fixed. In an example, one or more of the high threshold or low threshold are adaptive. Additionally, the ambient noise shows up as variations between a few bins in the lower half of the MFCC delta-delta, as opposed to variations across the range of MFCC delta-delta bins. This difference may be used as another indicator of speech, such as may include weighting the standard deviation of the upper 10 bins more heavily in the average.

FIG. 6A shows a technique for establishing a threshold and comparison value, and FIG. 6B shows an output of a classifier applying an indicator using the threshold and comparison value of FIG. 6A. FIG. 6A shows an example of how the adaptive threshold in the first stage 130 may be adjusted. The first stage 130 may determine the average value of the spectral indicator over a specified time period, such as may include 100 milliseconds or 200 milliseconds, as illustrative examples. This average value may be stored as a noise mean. Then, the first stage 130 may calculate the standard deviation of the spectral indicator around the determined noise mean to obtain a reference value (e.g., the area of region 610). The first stage 130 may then determine the sum of the spectral indicator that exceeds the noise mean (e.g., an integral as shown in region 620) for another specified time period, such as a period that may approximately match the first period. If the area of region 620 exceeds the area of region 610 by a specified value, such as may include a specified integer multiple or floating point value, the second time period may be flagged as a candidate speech interval. If a time period is flagged as a candidate speech interval, it may not be used to adjust the noise mean. If a time period is not flagged as a candidate speech interval, it may be used to adjust the noise mean for future time periods, which may help the first stage 130 adapt to changing ambient noise levels.

FIG. 6B show an example of a portion of the first stage 130 spectral indicator including the indicator value, the mean value of the indicator for regions where speech is not detected, the logarithm of the signal-to-noise ratio, and the output (e.g., candidate speech interval determination) of the first stage 130. FIG. 6B shows that the noise mean tracks the spectral indicator except for regions where speech is detected, in which case the noise mean remains constant. The logarithm of the signal-to-noise ratio may be used as a tuned indicator of the difference in the areas of regions 610 and 620. When the logarithm exceeds a specified value, a candidate speech interval is flagged by the first stage 130.

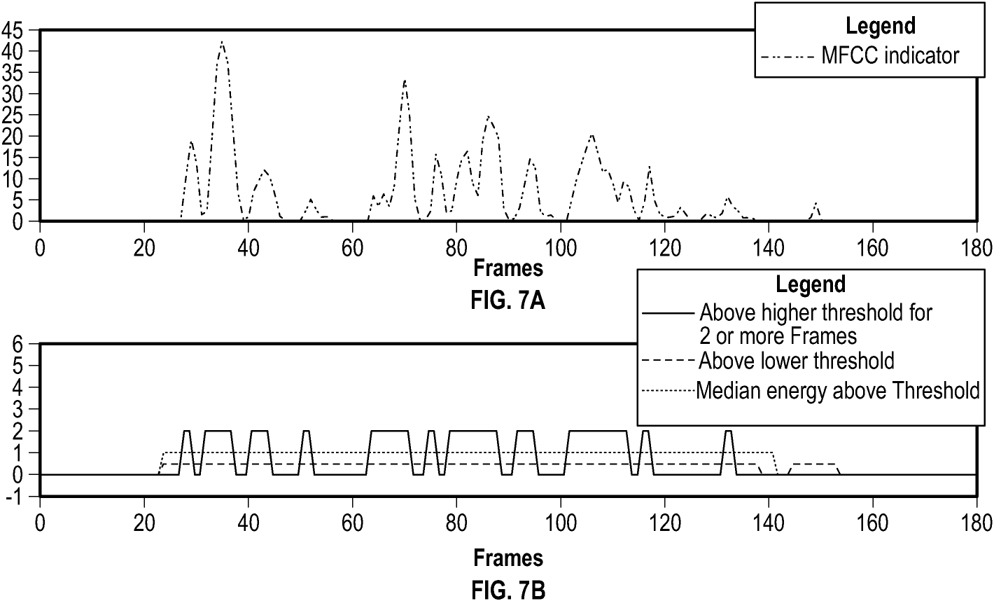

FIG. 7A and FIG. 7B show illustrative examples of outputs corresponding to indicators from a portion of a voice activity detection system 100. FIG. 7A shows the sum of half standard deviations of the MFCC delta-delta values, such as may be exiting the standard deviation block of the MFCC indicator 242. FIG. 7B shows that if the line of FIG. 7A is above the high threshold for 2 or more frames, above a low threshold, or the median energy of the MFCC is above a threshold, respective indicators go high. The three indicators shown in FIG. 7B may be combined in various fashions to determine the output of the MFCC indicator 242. For example, the output of the MFCC indicator 242 may indicate speech is likely present any time the high threshold is exceeded. In an example, the output of the MFCC indicator 242 may not indicate speech is likely present if the mean energy is not above the threshold, regardless of the delta-delta indicator. In an example, one or more of the high threshold, the low threshold, or the median energy threshold may be used to trim one or more of the beginning of candidate speech intervals or the end of candidate speech intervals.

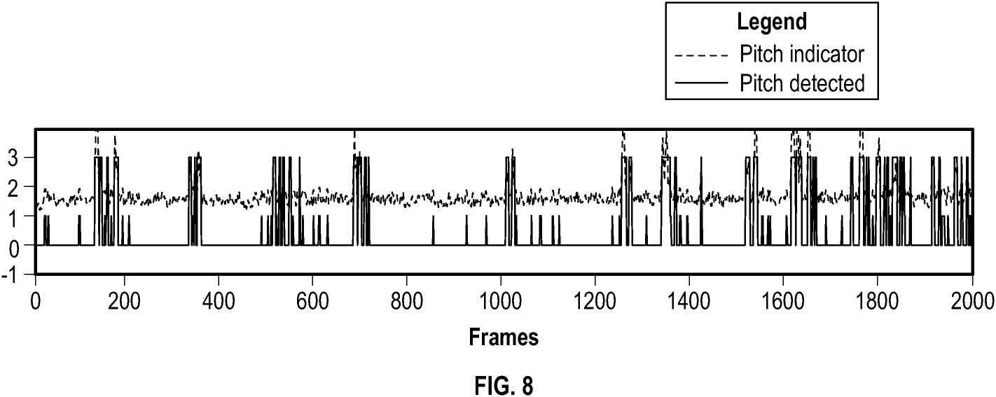

FIG. 8 shows an illustrative example of outputs corresponding to indicators from a portion of a voice activity detection system 100. FIG. 8 shows the output of the pitch indicator, such as may include the output of the time limit block in the pitch indicator 244, and the determination of whether pitch is present, such as may include the output of the pitch indicator 244. FIG. 8 shows that pitch may only be present for short portions of speech, and may not be present for all speech. However, pitch may still be useful in a voice activity detection system 100, such as for a cross-check as to whether speech is likely present. In an example, if pitch is present for any portion of a candidate speech interval, it may be flagged as likely containing speech. This may help improve the specificity of the voice activity detection system 100. Also, the techniques described can still be used without pitch information, but may have a greater frequency of false detections of speech.

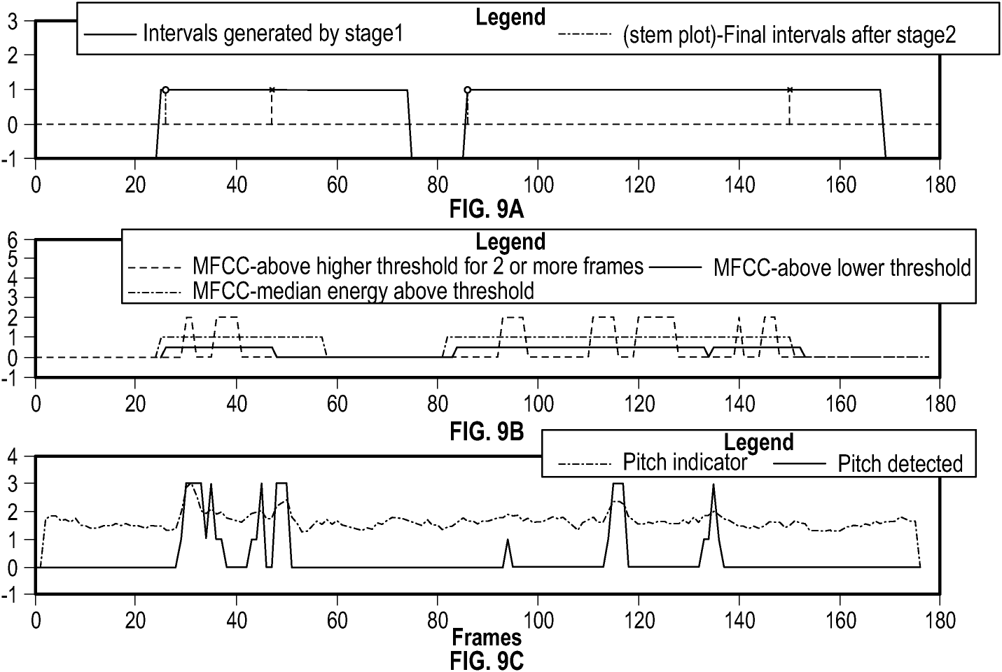

FIG. 9A, FIG. 9B, and FIG. 9C show illustrative examples of outputs corresponding to indicators from a portion of a voice activity detection system 100. FIG. 9A shows the candidate speech intervals flagged by the first stage 130, and the final output speech intervals of the voice activity detection system 100 output on the outgoing gated digital audio signal node 170. FIG. 9B shows the MFCC indicators generated by the MFCC indicator 242 of the voice activity detection system 100. FIG. 9C shows the pitch indicators generated by the pitch indicator 244 of the voice activity detection system 100. FIG. 9A, FIG. 9B, and FIG. 9C show that the intervals from the first stage 130 in FIG. 9A are initially broad and are refined by the second stage 140. The final intervals shown in FIG. 9A both include at least one positive indication from the pitch indicator 244 shown in FIG. 9C, and at least a portion of the MFCC delta-delta exceeding the high indicator. The intervals may begin when two or more of the low threshold, median energy threshold, or high threshold are exceeded, such as may include consistently exceeded, in a specified interval duration, such as may include 200 milliseconds. The intervals may end when one or more of the low threshold, median energy threshold, or high threshold are not exceeded, such as may include consistently not exceeded, in a specified interval duration, such as may include 200 milliseconds. In an example, the device that is receiving the audio signal on the outgoing gated digital audio signal node 170 may be configured to determine the end of the speech interval. In an example the voice activity detection system 100 may wait for a period of inactivity to end the speech interval, such as may include 400 milliseconds of inactivity as an illustrative example.

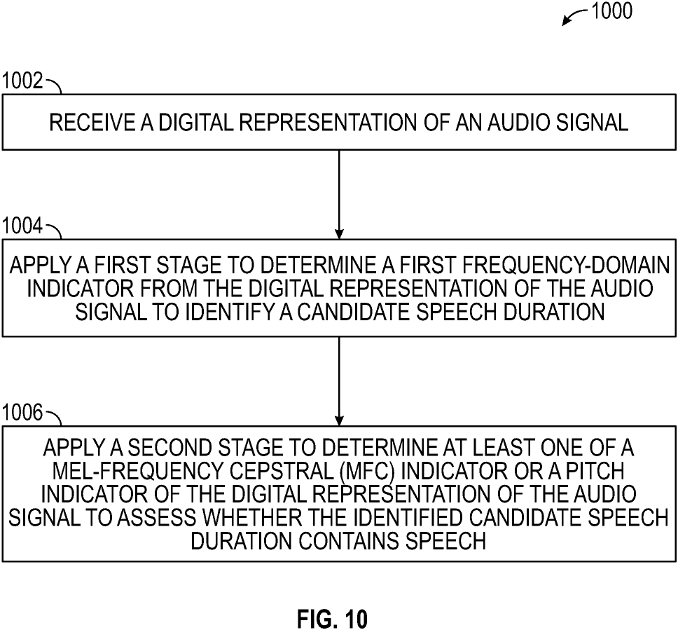

FIG. 10 is a flow chart 1000 showing an example of a method for operating portions of a voice activity detection system 100. At 1002 – a digital representation of an audio signal can be received. At 1004 – a first stage can be applied to determine a first frequency-domain indicator from the digital representation of the audio signal to identify a candidate speech duration. At 1006 – a second stage can be applied to determine at least one of a mel-frequency cepstral (MFC) indicator or a pitch indicator of the digital representation of the audio signal to assess whether the identified candidate speech duration contains speech. The shown order of steps is not intended to be a limitation on the order the steps are performed in. In an example, two or more steps may be performed simultaneously or at least partially concurrently. The steps shown in FIG. 10 may be performed on a system, such as the voice activity detection system 100.

In an example, a method may include a third stage. The third stage may be applied to gate a candidate speech interval by duration to determine whether the candidate speech interval likely contains speech. The third stage may be applied after the second stage, or the third stage may be applied in parallel with one or more of the other stages.

As an illustration, noise reduction can be implemented after a transformation into the frequency domain, where the signal is represented by amplitude or energy values at different frequencies. For spectral sub-bands, frequency-specific attenuation factors can be established and applied to amplitude or energy values of components in the sub-bands. In this manner, noise is attenuated in the corresponding sub-bands. The attenuation factors can be calculated for some or all frequencies using frequency-specific minimum values and can be updated for each respective signal frame being processed or according to another scheme. The minimum values can be determined as time-averaged values of the lowest amplitude for corresponding frequencies in a preceding time interval, where a rate or duration of averaging can be established in dependence on an estimated speech probability associated with a signal frame. In one approach, attenuation factors are, for each frequency, calculated as one minus a quotient of minimum value and current amplitude at the respective frequency, such as having a tunable lower threshold beyond which the signal amplitude will not be further reduced. Such a threshold can set a selected strength or degree of noise reduction. Prior to multiplication with an amplitude of a corresponding frequency, attenuation factors can be smoothed, such as averaged in both time and frequency.

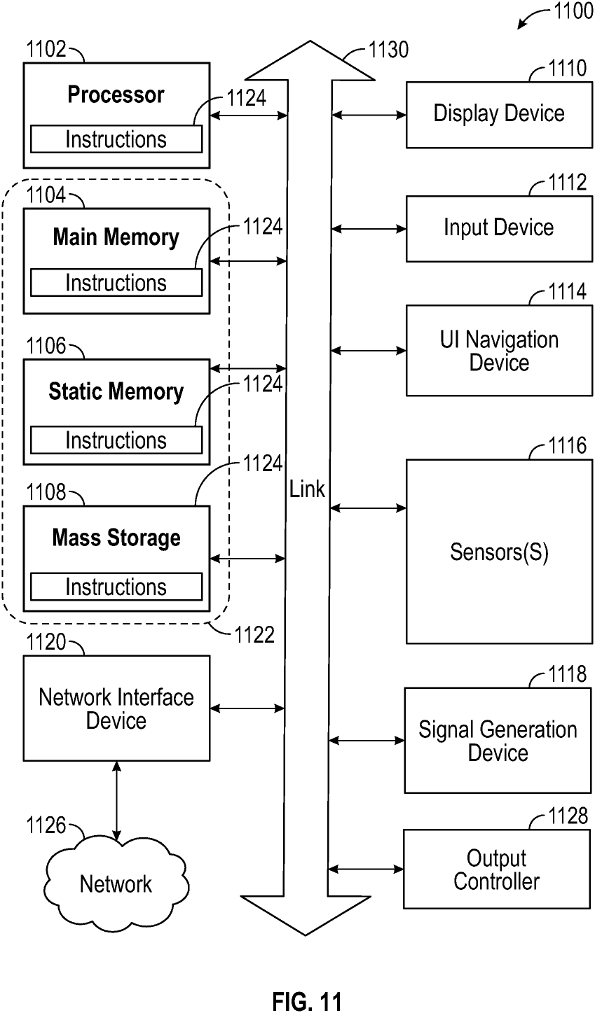

FIG. 11 illustrates a block diagram of an example machine 1100 upon which any one or more of the techniques (e.g., methodologies) discussed herein may perform. Examples, as described herein, may include, or may operate by, logic or a number of components, or mechanisms in the machine 1100. Circuitry (e.g., processing circuitry) is a collection of circuits implemented in tangible entities of the machine 1100 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 1100 follow.

In alternative embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environment. The machine 1100 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 1100 may include a hardware processor 1102 (e.g., a central processing unit (CPU), a graphics processing unit (GPU), a hardware processor core, or any combination thereof), a main memory 1104, a static memory (e.g., memory or storage for firmware, microcode, a basic-input-output (BIOS), unified extensible firmware interface (UEFI), etc.) 1106, and mass storage 1108 (e.g., hard drives, tape drives, flash storage, or other block devices) some or all of which may communicate with each other via an interlink (e.g., bus) 1130. The machine 1100 may further include a display unit 1110, an alphanumeric input device 1112 (e.g., a keyboard), and a user interface (UI) navigation device 1114 (e.g., a mouse). In an example, the display unit 1110, input device 1112 and UI navigation device 1114 may be a touch screen display. The machine 1100 may additionally include a storage device (e.g., drive unit) 1108, a signal generation device 1118 (e.g., a speaker), a network interface device 1120, and one or more sensors 1116, such as a global positioning system (GPS) sensor, compass, accelerometer, or other sensor. The machine 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1102, the main memory 1104, the static memory 1106, or the mass storage 1108 may be, or include, a machine readable medium 1122 on which is stored one or more sets of data structures or instructions 1124 (e.g., software) embodying or utilized by any one or more of the techniques or functions described herein. The instructions 1124 may also reside, completely or at least partially, within any of registers of the processor 1102, the main memory 1104, the static memory 1106, or the mass storage 1108 during execution thereof by the machine 1100. In an example, one or any combination of the hardware processor 1102, the main memory 1104, the static memory 1106, or the mass storage 1108 may constitute the machine readable media 1122. While the machine readable medium 1122 is illustrated as a single medium, the term “machine readable medium” may include a single medium or multiple media (e.g., a centralized or distributed database, and/or associated caches and servers) configured to store the one or more instructions 1124.

The term “machine readable medium” may include any medium that is capable of storing, encoding, or carrying instructions for execution by the machine 1100 and that cause the machine 1100 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 1122 may be representative of the instructions 1124, such as instructions 1124 themselves or a format from which the instructions 1124 may be derived. This format from which the instructions 1124 may be derived may include source code, encoded instructions (e.g., in compressed or encrypted form), packaged instructions (e.g., split into multiple packages), or the like. The information representative of the instructions 1124 in the machine readable medium 1122 may be processed by processing circuitry into the instructions to implement any of the operations discussed herein. For example, deriving the instructions 1124 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 1124.

In an example, the derivation of the instructions 1124 may include assembly, compilation, or interpretation of the information (e.g., by the processing circuitry) to create the instructions 1124 from some intermediate or preprocessed format provided by the machine readable medium 1122. The information, when provided in multiple parts, may be combined, unpacked, and modified to create the instructions 1124. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 1124 may be further transmitted or received over a communications network 1126 using a transmission medium via the network interface device 1120 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 1120 may include one or more physical jacks (e.g., Ethernet, coaxial, or phone jacks) or one or more antennas to connect to the communications network 1126. In an example, the network interface device 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1100, and includes digital or analog communications signals or other intangible medium to facilitate communication of such software. A transmission medium is a machine readable medium.

### Additional Notes & Examples

Example 1 is a machine-implemented method for detecting voice activity, the method comprising: receiving a digital representation of an audio signal; applying a first stage comprising determining a first frequency-domain indicator from the digital representation of the audio signal to identify a candidate speech duration; and applying a second stage comprising determining at least one of a mel-frequency cepstral (MFC) indicator or a pitch indicator from the digital representation of the audio signal to assess whether the identified candidate speech duration contains speech.

In Example 2, the subject matter of Example 1 optionally includes establishing respective frames defining specified durations within the digital representation of the audio signal, wherein at least one of the first stage or the second stage operates on at least one of the respective frames.

In Example 3, the subject matter of Example 2 optionally includes wherein the receiving a digital representation of an audio signal comprises receiving a streamed representation; and wherein the establishing respective frames includes assigning or receiving the respective frames based on the streamed representation.

In Example 4, the subject matter of any one or more of Examples 2-3 optionally include wherein the first frequency-domain indicator includes determining a representation of a frequency dispersion of spectral components of the digital representation of the audio signal, the dispersion determined from a frequency domain transform corresponding to one frame.

In Example 5, the subject matter of Example 4 optionally includes comparing the determined representation of the dispersion with a first threshold and declaring a candidate speech duration in response to a result of the comparison.

In Example 6, the subject matter of Example 5 optionally includes adjusting the first threshold based upon a central tendency of the first frequency-domain indicator determined using multiple frames.

In Example 7, the subject matter of Example 6 optionally includes wherein the first threshold is adjusted based upon frames that are determined not to contain speech.

In Example 8, the subject matter of any one or more of Examples 2-7 optionally include wherein the second stage comprises a pitch indicator, the pitch indicator comprising an inverse frequency domain transform of: a logarithm of a frequency domain transform of a time-domain representation of a respective one of the frames amongst the respective frames.

In Example 9, the subject matter of Example 8 optionally includes wherein the pitch indicator includes determining a central tendency of a magnitude of a specified range of bins within the inverse frequency domain transform.

In Example 10, the subject matter of Example 9 optionally includes comparing the determined central tendency to a threshold and declaring a candidate speech duration to be speech if the threshold is exceeded.

In Example 11, the subject matter of any one or more of Examples 1-10 optionally include wherein the second stage comprises an MFC indicator.

In Example 12, the subject matter of Example 11 optionally includes wherein the MFC indicator includes determining a representation of a dispersion of the MFC of the digital representation of the audio signal, the dispersion determined from an MFC transform corresponding to at least two frames.

In Example 13, the subject matter of Example 12 optionally includes comparing the determined representation of dispersion of the MFC to at least one threshold and at least one of adjusting a candidate speech duration or declaring a candidate speech duration to be speech in response to a result of the comparison.

In Example 14, the subject matter of any one or more of Examples 1-13 optionally include wherein the second stage comprises both an MFC indicator and a pitch indicator.

In Example 15, the subject matter of any one or more of Examples 1-14 optionally include sending a duration determined to contain speech to another system.

In Example 16, the subject matter of Example 15 optionally includes wherein the sending the duration determined to contain speech to another system occurs at least partially concurrently with the receiving a digital audio signal corresponding to the duration.

In Example 17, the subject matter of any one or more of Examples 1-16 optionally include applying a third stage comprising at least one temporal indicator to assess whether the identified candidate speech duration contains speech.

In Example 18, the subject matter of Example 17 optionally includes wherein the candidate speech duration is determined not to contain speech if a temporal length of the duration is less than a specified value.

Example 19 is a machine-implemented method for detecting voice activity, the method comprising: receiving a digital representation of an audio signal; establishing respective frames defining specified durations within the digital representation of the audio signal; applying a first stage comprising determining a first frequency-domain indicator from at least one of the respective frames of the digital representation of the audio signal to identify a candidate speech duration; and applying a second stage comprising determining a mel-frequency cepstral (MFC) indicator from at least one of the respective frames of the digital representation of the audio signal to assess whether the identified candidate speech duration contains speech.

Example 20 is a voice activity detection (VAD) system, the system comprising: a receiver circuit, configured to receive a digital representation of an audio signal; and a processor circuit coupled with a memory circuit, the memory circuit containing instructions that, when executed by the processor circuit, cause the processor circuit to: apply a first stage comprising determining a first frequency-domain indicator from the digital representation of the audio signal to identify a candidate speech duration; and apply a second stage comprising determining at least one of a mel-frequency cepstral (MFC) indicator or a pitch indicator from the digital representation of the audio signal to assess whether the identified candidate speech duration contains speech.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like.

Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A machine-implemented method for detecting voice activity, the method comprising:
receiving a digital representation of an audio signal;
applying a first stage comprising determining a first frequency-domain indicator from the digital representation of the audio signal to identify a candidate speech duration; and
applying a second stage comprising determining at least one of a mel-frequency cepstral (MFC) indicator or a pitch indicator from the digital representation of the audio signal to assess whether the identified candidate speech duration contains speech.

2. The method of claim 1, comprising establishing respective frames defining specified durations within the digital representation of the audio signal, wherein at least one of the first stage or the second stage operates on at least one of the respective frames.

3. The method of claim 2, wherein the receiving a digital representation of an audio signal comprises receiving a streamed representation; and
wherein the establishing respective frames includes assigning or receiving the respective frames based on the streamed representation.

4. The method of claim 2, wherein the first frequency-domain indicator includes determining a representation of a frequency dispersion of spectral components of the digital representation of the audio signal, the dispersion determined from a frequency domain transform corresponding to one frame.

5. The method of claim 4, comprising comparing the determined representation of the dispersion with a first threshold and declaring a candidate speech duration in response to a result of the comparison.

6. The method of claim 5, further comprising adjusting the first threshold based upon a central tendency of the first frequency-domain indicator determined using multiple frames.

7. The method of claim 6, wherein the first threshold is adjusted based upon frames that are determined not to contain speech.

8. The method of claim 2, wherein the second stage comprises a pitch indicator, the pitch indicator comprising an inverse frequency domain transform of:
a logarithm of a frequency domain transform of a time-domain representation of a respective one of the frames amongst the respective frames.

9. The method of claim 8, wherein the pitch indicator includes determining a central tendency of a magnitude of a specified range of bins within the inverse frequency domain transform.

10. The method of claim 9, comprising comparing the determined central tendency to a threshold and declaring a candidate speech duration to be speech if the threshold is exceeded.

11. The method of claim 1, wherein the second stage comprises an MFC indicator.

12. The method of claim 11, wherein the MFC indicator includes determining a representation of a dispersion of the MFC of the digital representation of the audio signal, the dispersion determined from an MFC transform corresponding to at least two frames.

13. The method of claim 12, comprising comparing the determined representation of dispersion of the MFC to at least one threshold and at least one of adjusting a candidate speech duration or declaring a candidate speech duration to be speech in response to a result of the comparison.

14. The method of claim 1, wherein the second stage comprises both an MFC indicator and a pitch indicator.

15. The method of claim 1, comprising sending a duration determined to contain speech to another system.

16. The method of claim 15, wherein the sending the duration determined to contain speech to another system occurs at least partially concurrently with the receiving a digital audio signal corresponding to the duration.

17. The method of claim 1, comprising applying a third stage comprising at least one temporal indicator to assess whether the identified candidate speech duration contains speech.

18. The method of claim 17, wherein the candidate speech duration is determined not to contain speech if a temporal length of the duration is less than a specified value.

19. A machine-implemented method for detecting voice activity, the method comprising:
receiving a digital representation of an audio signal;
establishing respective frames defining specified durations within the digital representation of the audio signal;
applying a first stage comprising determining a first frequency-domain indicator from at least one of the respective frames of the digital representation of the audio signal to identify a candidate speech duration; and
applying a second stage comprising determining a mel-frequency cepstral (MFC) indicator from at least one of the respective frames of the digital representation of the audio signal to assess whether the identified candidate speech duration contains speech.

20. A voice activity detection (VAD) system, the system comprising:
a receiver circuit, configured to receive a digital representation of an audio signal; and
a processor circuit coupled with a memory circuit, the memory circuit containing instructions that, when executed by the processor circuit, cause the processor circuit to:
apply a first stage comprising determining a first frequency-domain indicator from the digital representation of the audio signal to identify a candidate speech duration; and
apply a second stage comprising determining at least one of a mel-frequency cepstral (MFC) indicator or a pitch indicator from the digital representation of the audio signal to assess whether the identified candidate speech duration contains speech.
